(19) United States
(12) Patent Application Publication
(10) Pub. No.: US 2026/0365356 A1
(43) Pub. Date: Nov. 19, 2026

(54) HANDLING DEVICE FOR AN ISOLATOR COMPRISING A COUPLING INTERFACE, AND ISOLATOR COMPRISING SUCH A HANDLING DEVICE

(71) Applicant: Syntegon Technology GmbH, Stuttgart (DE)

(72) Inventors: Johannes Bäuerle, Obersontheim (DE); Marcus Kleinert, Wallhausen (DE)

(21) Appl. No.: 19/675,840

(22) Filed: May 13, 2026

(30) Foreign Application Priority Data
May 19, 2025 (DE) 10 2025 119 389.4

(51) Int. Cl. B65B 43/54; B25J 11/00

(52) U.S. Cl. CPC B65B 43/54; B25J 11/00

(57) ABSTRACT

A handling device (10) includes a coupling interface, in particular for coupling to a filling needle holder, for an isolation region.

### BACKGROUND

The present invention relates to a handling device comprising a coupling interface, in particular for coupling to a filling needle holder, for an isolation region. The invention also relates to an isolator and a method for the operation thereof.

An isolator separates an isolation region, in particular a sterile or disinfected one, with a controlled atmosphere from an external environment, for example an operating or drive region. In such sterile isolation regions, particularly in pharmaceutical production, filling needles are used to fill products, in particular pharmaceutical products. This requires that the filling needles be moved in a controlled manner within isolation regions without endangering sterility.

Handling devices are known from the prior art that accommodate filling needle holders including filling needles by producing a vertical movement. This vertical movement also allows the filling needles to be immersed in and removed from the container to be filled.

Other systems work with a horizontal offset and can superimpose vertical and horizontal movements.

In known designs, the problem arises that the movements, which are transmitted from an operating region to the isolation region by means of feedthroughs, cross the sterility barrier, which can result in a violation of the sterility barrier if components are moved back and forth across the sterility barrier. Typically, attempts are made to prevent the introduction of contamination via seals or similar means.

### SUMMARY

The present invention is based on the object of providing an advantageous option for operating a handling device in an isolation region.

The object is achieved by a handling device according to the disclosure, an isolator according to the disclosure, and a method according to the disclosure, as well as solutions described below.

According to the invention, a handling device comprising a coupling interface is provided. The coupling interface is used, for example, for coupling tools, in particular to a filling needle holder. The handling device is provided for use in an isolator, wherein the isolator is configured with a controlled atmosphere, in particular a sterile or disinfected atmosphere.

The isolation region is separated by a partition wall from a drive region, in particular an operating region, which may be non-sterile or contaminated, and where personnel may be present or have access. The drive region can also be separately encapsulated.

The handling device further comprises a drive portion with at least one drive, a transmission portion, and a manipulator portion. The transmission portion is configured to transmit a drive movement from the drive to the manipulator portion.

The manipulator portion is configured to move the coupling interface relative to the transmission portion. The transmission portion is configured in such a way that, in an installed state, it extends through the partition wall of the isolator. In the installed state, the manipulator portion is located within the isolation region, and the drive portion is located in the drive region, in particular the operating region.

The drive(s) are arranged outside the isolator to prevent them from releasing contamination into the protected environment, e.g., due to wear of moving parts.

Furthermore, according to the invention, it is provided that the transmission portion comprises at least one transmission shaft. The transmission shaft transmits the drive movement from the drive to the manipulator portion by means of a rotational movement. The transmission shaft transmits the drive movement without translation. Thus, transmission occurs without any part of the transmission portion moving back and forth through the sterility barrier. During rotation, the transmission shaft always remains in the same position with respect to the sterility barrier. In other words, no part of the transmission shaft moves from the drive region into the isolation region or vice versa. This ensures that the sterility of the isolation region is maintained particularly reliably.

The manipulator portion of the handling device can comprise at least two arm portions. In a preferred embodiment, the manipulator portion is configured with at least three, in particular exactly three, arm portions. The arm portions are movable relative to each other. The arm portions are preferably coupled to each other via pivot joints.

The transmission portion can further comprise a plurality of, in particular one per arm portion, in particular three, transmission shafts arranged concentrically to each other. Here, a first and a second transmission shaft can be configured as a hollow shaft. In other words, the second and third transmission shafts run within the hollow first and second transmission shafts.

The handling device can also be configured such that the drive movement from at least one transmission shaft is transmitted via a V-belt (V-belts are inexpensive but prone to slippage, which can lead to wear and reduced accuracy, but this can be accepted depending on the requirements or compensated for by appropriate controlling), a toothed belt, a timing chain or a cardan joint to a pivot joint of the manipulator portion. V-belts are advantageous here because they offer great flexibility, low cost, and require little maintenance. Furthermore, they can dampen vibrations, which makes their use particularly advantageous when handling sensitive products.

Toothed belts are inexpensive and lightweight, which reduces the overall energy required to transmit the movement. The maintenance interval for this component is easily predictable, which allows for reliable planning. Timing chains are advantageous because they are comparatively durable, robust, and therefore require little maintenance.

Cardan joints allow for a large angle compensation; in other words, they allow a variety of different angles between the arm portions via which the movement can be transmitted. At the same time, cardan joints are robust and require little maintenance. The use of spur gears or a spur gear transmission is also advantageous.

A drive for at least one arm portion, in particular the drive of an arm portion which is indirectly connected to the transmission portion via at least one other arm portion, can be arranged in one of the arm portions and/or one of the pivot joints of the arm portions.

Furthermore, the handling device may have at least one movable actuating element that is arranged at the coupling interface. The actuating element is here configured in such a way that, when actuated by means of a locking device, it can lock the coupling interface with a coupled filling needle holder, in particular in a positively fitting manner. In other words, actuating the actuating element results in a more stable and secure connection between the filling needle holder and the coupling interface. The locking device can be actuated via the actuating element.

The handling device can further be configured such that the actuating element is coupled to a connecting piece rotatably mounted in the locking unit and the connecting piece is connected to a locking element, in particular a pin-type one. The locking element can be moved into a locking gap, located on the filling needle holder to be coupled, by actuating the actuating element. By engaging in the locking gap, the locking element locks the filling needle holder at the coupling interface.

Furthermore, according to the invention, the handling device can be configured such that the locking gap tapers along its extent, so that when locking the filling needle holder, the locking element forces the filling needle holder into a defined position by engaging in the locking gap. For example, in such a way that the locking element is clamped into the tapered gap.

Another embodiment according to the invention provides that the locking device is actuated by a pivoting movement, in particular a pivoting movement about a coupling direction, of the actuating element. In this case, in particular a connecting piece, which is connected to the actuating element, extends in elongate fashion in the coupling direction, wherein the coupling interface can be moved along the coupling direction into a corresponding receptacle on the filling needle holder.

Another possible embodiment is that an abutment portion for actuating the actuating element is located on the manipulator portion, in particular on an arm of the manipulator portion that is directly pivotably connected to the transmission portion. The abutment portion can be configured here in particular to be elongate or pin-shaped. An advantageous embodiment provides that the abutment portion can actuate the actuating element by vertical rotation and/or by vertical movement of the arms.

The invention also relates to an assembly comprising a handling device as described herein and a filling needle holder coupled to the coupling interface, in particular wherein a portion of the coupling interface that tapers along the coupling direction is arranged in a corresponding receptacle of the filling needle holder. In this embodiment, the locking element of the coupling interface can lock the filling needle holder to the coupling interface by engaging in the locking gap, in particular, wherein the locking element can be moved out of the locking position by a pivoting movement of the actuating element.

A part of the invention is also an isolator comprising a handling device or the assembly of handling device and coupled filling needle holder, as defined at the outset or subsequently in the description.

The handling device is inserted into the partition wall of the isolator with the aid of a feedthrough that preserves the sterility of the isolation region, wherein the manipulator portion and the coupling interface are arranged in the isolation region and the drive portion or the drives are arranged in the operating region and the transmission portion extends through the partition wall from the drive portion to the manipulator portion. In other words, the manipulator portion is located within the isolation region, and the drive portion is in a potentially non-sterile drive region.

A part of the invention is also a method for operating a handling device as described here. The method comprises the steps of:
a) moving the handling device to a filling needle holder,
b) coupling the filling needle holder to the coupling interface,
c) optionally, moving the actuating element to the abutment portion and actuating the actuating element by means of the abutment portion in order to lock the coupling interface. Locking here means that the coupling interface and the filling needle holder cannot be separated without prior unlocking, in particular by moving the actuating element back to its original position.
d) moving the coupled filling needle holder vertically and optionally horizontally towards the location of use.

### BRIEF DESCRIPTION OF THE DRAWINGS

The invention is described in more detail below with reference to the drawings, the same or functionally equivalent elements being provided only once with reference signs if necessary.

FIG. 1 is a schematic overview of the isolation and operating region with a handling device in the installed state;

FIG. 2 shows transmission shafts with a first and second transmission shaft configured as a hollow shaft;

FIG. 3 is a schematic view of a manipulator portion with a coupling interface;

FIG. 4 is a perspective view of the drive region and isolation region with the handling device with coupled filling needle holder;

FIG. 5 is a perspective view of the coupling interface with coupled filling needle holder;

FIG. 6 shows a cross section through the coupling interface with coupled filling needle holder;

FIG. 7 is a view of a manipulator portion with a filling needle holder coupled to the coupling interface at a location of use.

### DETAILED DESCRIPTION

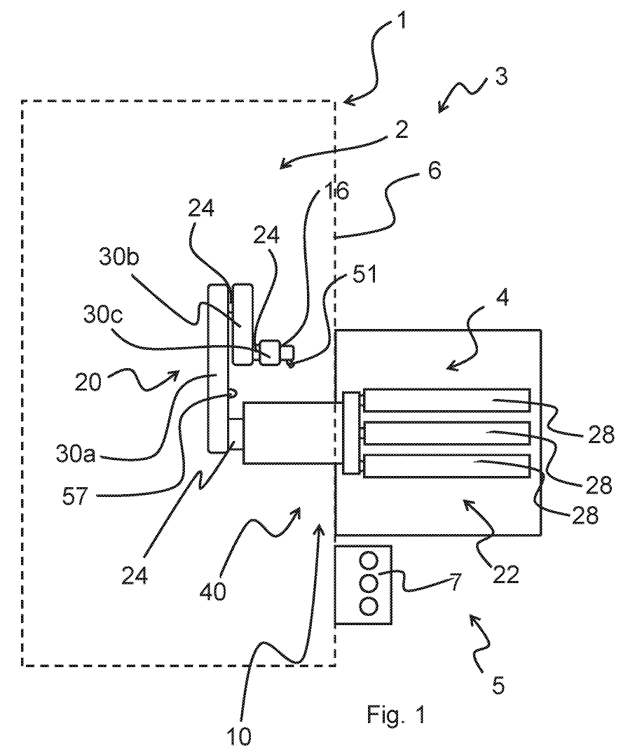

FIG. 1 schematically shows an isolator 1. The isolator 1 separates a sterile or disinfected isolation region 2, by means of a partition wall (dashed line) 6, from an environment 3 that comprises a drive region 4, which in this case is arranged in an operating region 5 of the isolator 1. For example, operating elements 7 for operating equipment in the isolation region 2 can be arranged in the operating region 5.

The isolator 1 comprises a handling device 10 according to the invention. FIG. 1 shows the handling device 10 according to the invention in its installed state. The handling device 10 comprises a manipulator portion 20, a drive portion 22, and a transmission portion 40. The manipulator portion 20 is arranged in the isolation region 2. The drive portion 22 is arranged outside the isolation region 2, more precisely in the drive region 4. In this case, the drive region 4 is again self-contained but is separated from the isolation region 2 by the partition wall 6. The transmission portion 40 connects the drive portion 22 to the manipulator portion 20. For this purpose, the transmission portion 40 extends through the partition wall 6.

The drive portion comprises three drives 28. The manipulator portion 20 comprises three arm portions 30a/30b/30c, which are connected to each other or to the transmission portion 40 via pivot joints 24.

An abutment portion 57 is configured on a first arm portion 30a. A second arm portion 30b connects the first arm portion 30a to a third arm portion 30c. On the third arm portion 30c, a coupling interface 16 is arranged, on which an actuating element 51 is arranged. In FIG. 1, the actuating element 51 is shown in an unlocked position.

By superimposing the pivoting movements of the three arm portions 30a/30b/30c, it is possible to perform both horizontal and vertical movements with the coupling interface 16. Movements of the arm portions 30a/30b/30c further enable an actuation of the actuating element 51 at the abutment portion 57.

The drive movement of the drives 28 can be transmitted from the drive portion 22 to the manipulator portion 20 via transmission shafts 42/44/46 arranged in the transmission portion 40.

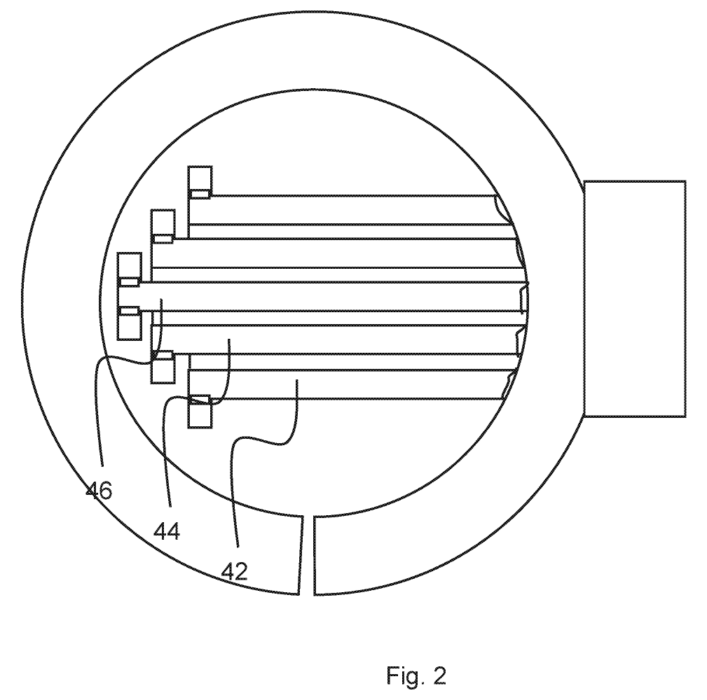

FIG. 2 shows three transmission shafts 42/44/46 in a schematic cross section. The first transmission shaft 42 and the second transmission shaft 44 are each configured as a hollow shaft. The second transmission shaft 44 is arranged running within the first transmission shaft 42 and the third transmission shaft 46 is arranged running within the second transmission shaft 44. The transmission shafts 42/44/46 are arranged concentrically to each other.

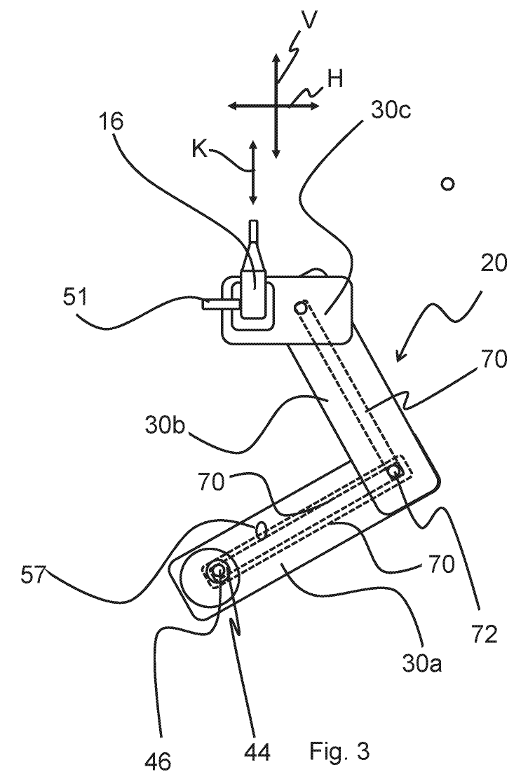

FIG. 3 is a schematic view of the manipulator portion 20 in an extended state. A vertical direction V and a horizontal direction H are represented by corresponding axes. By moving the arm portions 30a/30b/30c relative to each other, a horizontal and/or vertical movement of the coupling interface 16 can be effected. The three arm portions 30a/30b/30c are at different angles to each other. Here the actuating element 51 is arranged on the coupling interface 16.

The abutment portion 57 is arranged on the arm portion 30a. By moving the arm segments 30a/30b/30c relative to each other, in other words, by a pivoting movement of the individual arm segments 30a/30b/30c along the pivot joints 24, the actuating element 51 can be moved against the abutment portion 57 and thus the actuating element 51 can be actuated.

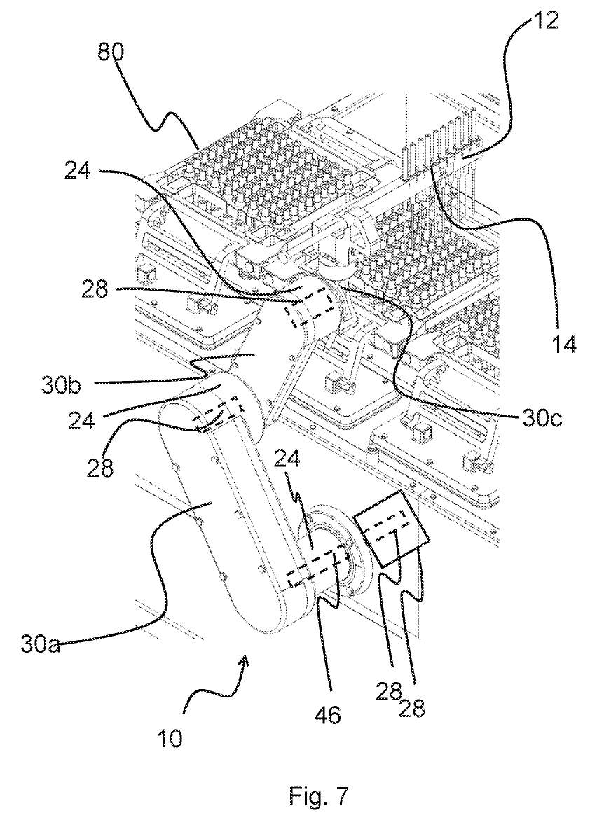

In the example of FIG. 3, V-belts 70 are shown, which run inside the arm segments 30a/30b/30c and transmit the drive torque of the drives 28 to the joints. To transmit torque to the joint 24 of the third arm segment 30c, two V-belts 70 are used, which are coupled via a coupling axle 72 in the joint 24 of the second arm segment 30b. Other types of coupling are possible within the meaning of the invention, for example, toothed belts, timing chains, or cardan joints. Alternatively, as illustrated in FIG. 7, the drives 28 of the second arm segment 30b and of the third arm segment 30c can also be arranged in the arm segments. The drives 28 of the second arm segment 30b and the third arm segment 30c can be configured less powerful and correspondingly smaller than the drive 28 of the first arm segment 30a, which is connected directly to the transmission portion 40.

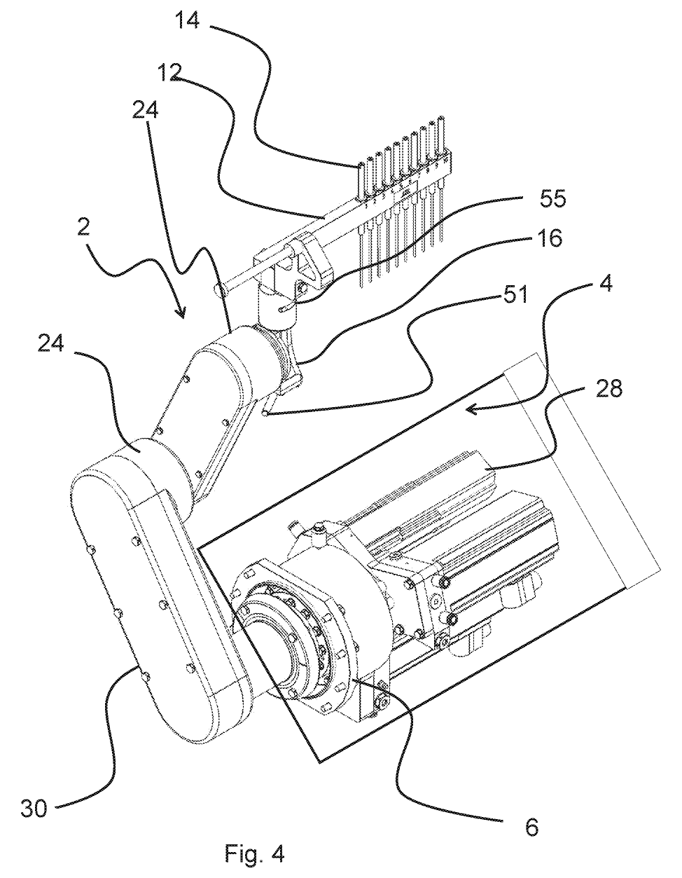

FIG. 4 shows a perspective view of the manipulator portion 20 in the isolation region 2 and the drive portion in the drive region 4. The coupling interface 16 is here coupled to a filling needle holder 12 with filling needles 14. The actuating element 51 is in the locked position and locks the filling needle holder 12 with the coupling interface 16.

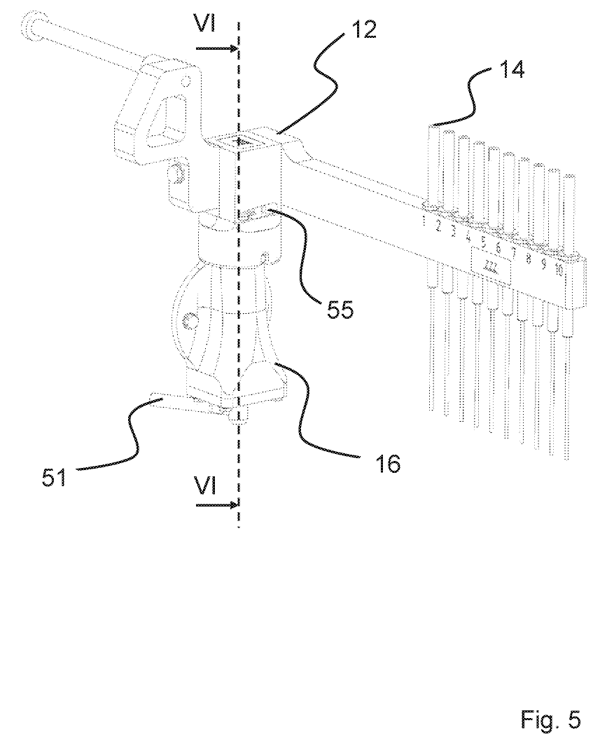

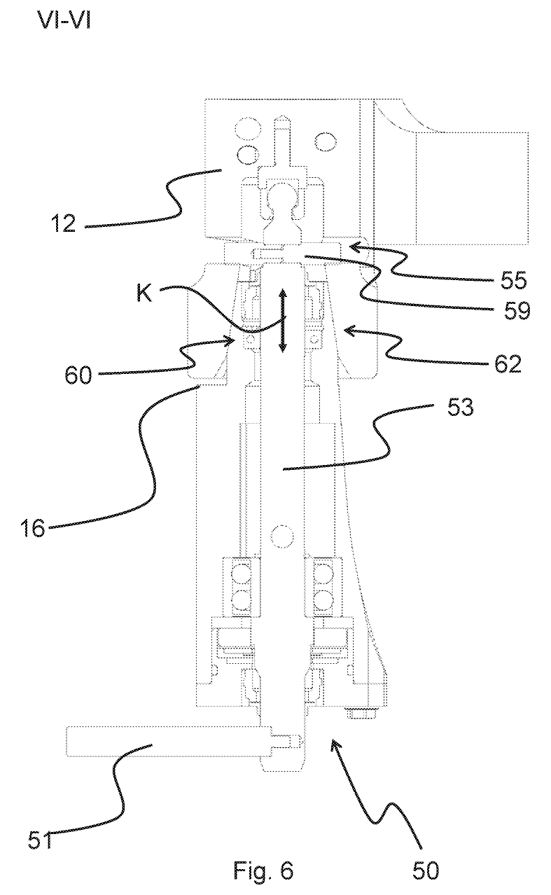

FIG. 5 shows a perspective view of the coupling interface 16 with a filling needle holder 12 with filling needles 14. FIG. 6 shows a sectional view along the line VI-VI from FIG. 5. A locking device 50 comprises a locking gap 55. A locking element 59 of the locking device 50 can lock the filling needle holder 12 at the coupling interface 16 by engaging in the locking gap 55. The locking element 59 can be pivoted into the locking gap 55 via the actuating element 51. The actuating element 51 is connected to the locking element 59 via a connecting piece 53 which is rotatably mounted in the locking device 50.

The locking element 59 and the locking gap 55 are configured such that, when locking the filling needle holder 12, the locking element 59 forces the filling needle holder 12 into a defined position by engaging in the locking gap 55. The locking device 50 can be actuated by a pivoting movement of the actuating element 51 about a coupling direction K. The coupling interface 16 can be moved along the coupling direction K into a corresponding receptacle 62 on the filling needle holder 12.

The connecting piece 53 is configured in this case to be elongate and extends in the coupling direction K.

To couple the coupling interface 16 to the filling needle holder 12, an insertion portion 60 of the coupling interface 16, tapering along the coupling direction K, is arranged in a corresponding receptacle 62 of the filling needle holder 12. For this purpose, the insertion portion 60 of the coupling interface 16 is inserted into the receptacle 62 of the filling needle holder 12 along the coupling direction K by movement of the arm segments 30a/30b/30c relative to each other.

FIG. 7 shows an alternative variant of the handling device 10 for filling liquids into nested containers 80. In the variant of FIG. 7, the manipulator portion 20 also has the 3 arm portions 30a/30b/30c. However, the transmission portion 40 comprises only one transmission shaft 46, which transmits a drive torque from a drive 28 in the drive portion 22 to the joint 24 of the first arm portion 30a. The drives 28 are arranged in the arm segments or the joints 24 at the joints 24 of the second arm segment 30b and the third arm segment 30c. The drives 28 of the second arm segment 30b and the third arm segment 30c can be configured less powerful and correspondingly smaller than the drive 28 of the first arm segment 30a, which is connected directly to the transmission portion 40. This makes an accommodation possible in the joint 24 or arm segment 30. The drives 28 in the joint 24 or arm segment 30 are encapsulated so that they cannot release any contamination to the isolation region 2.

1. A handling device (10) comprising a coupling interface (16) for an isolator (1), wherein the isolator is configured with a sterile or disinfected isolation region (2) which is separated by a partition wall (6) from a drive region (4), wherein
the handling device (10) comprises:
a drive portion (22) comprising at least one drive (28),
a transmission portion (40), and
a manipulator portion (20), wherein
the transmission portion (40) is configured to transmit a drive movement from the at least one drive (28) to the manipulator portion (20), and
the manipulator portion (20) is configured to move the coupling interface (16) relative to the transmission portion (40), wherein
the transmission portion (40) is configured such that, in an installed state, it extends through the partition wall (6) of the isolator (1), wherein
in the installed state the manipulator portion (20) is located within the isolation region (2) and
the drive portion (22) is located in the drive region (4),
wherein
the transmission portion (40) comprises at least one transmission shaft (42/44/46),
wherein the transmission portion (40) is configured such that transmission of drive motion from the at least one drive (28) to the manipulator portion (20) takes place by a rotational movement of at least one transmission shaft (42/44/46) of the transmission portion (40), wherein
the at least one transmission shaft (42/44/46) transmits the drive motion without translation.

2. The handling device (10) according to claim 1, wherein the manipulator portion (20) is configured with at least two arm portions (30a/30b/30c).

3. 3. The handling device (10) according to claim 2, wherein a drive (28) of at least one arm portion (30b/30c) is arranged in one of the arm portions (30a/30b/30c).

4. The handling device (10) according to claim 1, wherein the transmission portion (40) comprises at least three concentrically arranged transmission shafts (42/44/46), wherein a first (42) and a second transmission shaft (44) are configured as hollow shafts.

5. The handling device (10) according to claim 1, wherein the drive movement of at least one transmission shaft (44, 46) is transmitted via a V-belt (70), a toothed belt, a timing chain, or a cardan joint to a pivot joint (24) of the manipulator portion (20).

6. The handling device (10) according to claim 1, wherein at least one movable actuating element (51) is arranged at the coupling interface (16), wherein the at least one movable actuating element (51), when actuated, can lock a coupled filling needle holder (12) by a locking device (50).

7. The handling device (10) according to claim 6, wherein the at least one movable actuating element (51) is coupled to a connecting piece (53) rotatably mounted in the locking device (50) and the connecting piece (53) is connected to a locking element (59), wherein the locking element (59) can be moved into a locking gap (55) of the filling needle holder (12) to be coupled by actuating the at least one movable actuating element (51), so that the locking element (59) locks the filling needle holder (12) at the coupling interface (16) by engaging in the locking gap (55).

8. The handling device (10) according to claim 7, wherein the locking gap (55) tapers along its extent, so that when locking the filling needle holder (12), the locking element (59) forces the filling needle holder (12) into a defined position by engaging in the locking gap (55).

9. The handling device (10) according to claim 8, wherein the locking device (50) is actuated by a pivoting movement of the at least one movable actuating element (51), wherein the coupling interface (16) is movable along a coupling direction (K) into a corresponding receptacle on the filling needle holder (12).

10. The handling device (10) according to claim 6, wherein an abutment portion (57) for actuating the at least one movable actuating element (51) is located on the manipulator portion (20).

11. The handling device (10) according to claim 1, comprising a filling needle holder (12) which is coupled to the coupling interface (16).

12. An isolator (1) comprising a handling device (10) according to claim 1, wherein the handling device (10) is inserted into the partition wall (6) of the isolator (1) with aid of a feedthrough which preserves sterility of the isolation region (2), wherein the manipulator portion (20) and the coupling interface (16) are arranged in the isolation region (2), and the drives (28) are arranged in an operating region (5), and the transmission portion (40) extends through the partition wall (6) from the drives (28) to the manipulator portion (20).

13. A method for operating a handling device (10) according to claim 1, comprising the steps of:
a) moving the handling device (10) to a filling needle holder (12),
b) coupling the filling needle holder (12) to the coupling interface (16),
c) optionally, moving an actuating element (51) against an abutment portion (57) and actuating the actuating element (51) by the abutment portion (57) in order to lock the coupling interface (16),
d) moving the coupled filling needle holder (12) in a vertical (V) and/or horizontal direction (H) to a location of use.

14. The method according to claim 13, wherein coupling the filling needle holder (12) to the coupling interface (16) includes moving the coupling interface (16) along a coupling direction (K), wherein the coupling direction (K) runs in a vertical direction (V).

15. The handling device (10) according to claim 2, wherein the manipulator portion (20) is configured with at least three arm portions (30a/30b/30c).

16. The handling device (10) according to claim 2, wherein the arm portions (30a/30b/30c) are connected to each other via pivot joints (24).

17. The handling device (10) according to claim 9, wherein the pivoting movement is a pivoting movement about the coupling direction (K).

18. The handling device (10) according to claim 10, wherein the abutment portion (57) for actuating the at least one movable actuating element (51) is located on an arm portion (30a) of the manipulator portion (20) which is pivotably connected directly to the transmission portion (40).

19. The handling device (10) according to claim 11, wherein an insertion portion (60) of the coupling interface (16) tapering along a coupling direction is arranged in a corresponding receptacle (62) of the filling needle holder and a locking element (59) of the coupling interface (16) locks the filling needle holder (12) to the coupling interface (16) by engaging in a locking gap (55).

20. The handling device (10) according to claim 19, wherein the locking element (59) can be moved out of a locking position by a pivoting movement of an actuating element (51).
